(19) United States
(12) Patent Application Publication
(10) Pub. No.: US 2008/0288790 A1
(43) Pub. Date: Nov. 20, 2008

(54) Means and Method of Using Cryptographic Device to Combat Online Institution Identity Theft

(76) Inventor: Stephen Wilson, New South Wales (AU)

Correspondence Address: CHRISTIE, PARKER & HALE, LLP, PO BOX 7068, PASADENA, CA, 91109-7068, US

(21) Appl. No.: 11/578,217

(22) PCT Filed: Apr. 11, 2005
(86) PCT No.: PCT/AU05/00522

§ 371 Date: May 27, 2008

(30) Foreign Application Priority Data
Apr. 9, 2004 (AU) 2004100268

(51) Int. Cl. G06F 12/14

(52) U.S. Cl. 713/194

(57) ABSTRACT

Whereas smartcards and similar cryptographic devices may customarily be used to protect against personal identity theft, this invention stores Public Keys of an institution in cryptographic devices issued by the institution to its customers, in order to protect the institution's identity from being stolen. The invention improves the security of electronic business applications using Secure Sockets Layer, Secure E-mail, Object Signing and similar low level electronic business security functions by storing various Public Keys of the institution within the cryptographic device. The invention thereby helps to reduce the likelihood of “ghosting” an institution's web site (where an illegitimate web site seeks to mimic a genuine web site in order to defraud customers), and provides a means to overcome the problem of “phishing” (where illegitimate e-mails purporting to be from the institution are sent to customers in order to elicit personal information).

### TECHNICAL FIELD

The present invention relates to the conduct of electronic business, and in particular to reducing the incidence of perpetration of identity theft against an institution when electronically conducting business with a customer.

### BACKGROUND ART

Institutions which conduct electronic business can suffer from a number of types of identity fraud where an attacker assumes the identity of the institution. Such identity fraud includes:

establishing a bogus “ghost” web site that mimics the institution's genuine web site, and thereby defrauds customers using the ghost site instead of the genuine site;

sending a bogus e-mail to a customer, purporting to be from the institution, to elicit personal information such as account details, which may subsequently be misused; and

a corrupting critical data such as official notices or computer program code distributed by an institution to its customers.

A range of cryptographic security technologies are in use for helping customers of an institution verify the identity of that institution when transacting with it electronically. Yet certain of these counter-measures, including “Secure Sockets Layer” (SSL) and “Object Signing”, described further in the following, are now being subverted by attackers who would seek to perpetrate identity fraud against electronic business institutions.

Electronic business web sites are particularly vulnerable to attack by “ghosting”. In general, ghosting is effected by an attacker corrupting the mapping of web site domain names onto physical computer addresses, so that when a customer visiting the ghosted web site believes they are connected to a certain web server associated with the domain name, he or she is in fact connected to an illegitimate server controlled by thee attacker. If programmed so as to resemble the legitimate web site, the attacker's server can be used to defraud the unsuspecting customer.

One particularly widespread security technology is the “Secure Sockets Layer” (SSL) protocol, which is used in part to combat ghosting. SSL involves issuing the legitimate owner of a domain name with a digital certificate, and installing the certificate on a web server controlled by that owner. The so-called server certificate includes the precise domain name for the web server, and is digitally signed by the certificate issuer. The digital signature on the server certificate makes the server certificate itself effectively tamper resistant. The identity and legitimacy of a certificate issuer is typically conveyed by another digital certificate issued by a higher level issuer. Thus a chain of digital certificates extends from the server certificate back through a series of certificate issuers. Each digital certificate in the chain is digitally signed by its respective issuer. The certificate chain terminates with a “Root Public Key” certificate. If a given Root Public Key can be trusted as legitimate then all server certificates from issuers that are found to chain back to the trusted Root Public Key can also be trusted.

Many web browser applications have a so-called “Trust List” of trusted Root Public Keys, stored in computer memory, and used by browser software during the process of establishing each new SSL-secured web session. The Trust List is usually held on magnetic disc and/or random access memory. A Trust List may be pre-loaded into the web browser software by the browser manufacturer. The Trust List is usually also modifiable by the user, so that new Root Public Keys may be added at the user's discretion in order to support other certificate issuers.

During the process of establishing a connection to an SSL-secured web site, a web browser using the SSL protocol will perform a series of steps which help in part to determine the legitimacy of the web site. First, the web browser will check if a server certificate is installed on the web server. The web browser then scans the server certificate's contents and checks if the domain name listed in the certificate matches the expected domain name of the web site being visited. Finally, the web browser verifies that the server certificate chains back to a trusted Root Public Key certificate. If all these checks pass, then the browser establishes a secure web session with the web server. Browser software typically indicates to its user that the current web session is secure by displaying a padlock graphic or similar icon.

Wherever Root Public Keys, such as those that underpin SSL, are held in magnetic disc and/or random access memory, the Root Public Keys are vulnerable to a range of potential attacks from those who may seek to defraud electronic business users. One class of such vulnerabilities relates to ways in which Public Keys may be surreptitiously substituted by an attacker, thus subverting the protections offered by SSL.

One form of surreptitious Public Key substitution entails the attacker manipulating the Root Public Key Trust List. The formats of common browsers' Trust Lists are readily discernible by technically skilled attackers from generally available software specifications and/or by “reverse engineering” the browser software. Armed with knowledge of the format of a Trust List, an attacker can substitute bogus Root Public Key values. Said substitution can be effected by a variety of means, including computer viruses. The effect of inserting a bogus Root Public Key value into a browser Trust List is that SSL sessions can be established with ghosted web sites featuring counterfeit server certificates that chain back to the bogus Root Public Key, thus making the ghosted sites appear legitimate to the web browser and to unsuspecting users.

Another form of surreptitious Public Key substitution is known in the field of computer security as a “Man In The Middle” attack. This form of attack does not require substitution of Root Public Key values into a browser Trust List. Instead, it takes advantage of a known vulnerability in some browser software wherein the software places no restrictions on the length of the certificate chain from the server certificate back to a Root Public Key. Under these conditions, an attacker can obtain a certificate from a legitimate certificate issuer, use that certificate—termed the “Man In The Middle” certificate—to illicitly spawn a bogus certificate issuer, and use the bogus certificate issuer to create illegitimate server certificates. Most web browsers, when directed to a ghosted web site featuring such an illegitimate server certificate, will establish an SSL session merely because the Man In The Middle certificate is found to chain back to a trusted Root Public Key, albeit via an additional certificate. Thus the user may be led to believe that the ghosted web site is genuine.

One solution to this type of Man In The Middle attack is to tighten the rules used in browser software to check the certificate chain. For instance, browser software could be configured to only allow a certain number of certificates in the chain from the server certificate back to a Root Public Key in the Trust List. An attempted Man In The Middle attack under these conditions would be detected because the attack increases the certificate chain length by one. However, this type of defense against SSL Man In The Middle attacks is complicated by the fact that different certificate issuers prefer to use intrinsically different certificate chain lengths, for example to provide operational flexibility. This means that different web server certificates will exhibit different chain lengths, depending on the operational details of the respective server certificate issuers. It is therefore difficult to define a maximum certificate chain length which is characteristic of all legitimate web sites. A more robust defense against SSL Man In The Middle attacks is to ensure that the certificate chain for a given web site cannot be interfered with, no matter how long that chain might be.

Vulnerabilities relating to Public Key substitution affect not only SSL. Other cryptographic technologies are also vulnerable, including Object Signing (also known as Code Signing). Object Signing is a technique for protecting a given data object (such as a piece of executable program code) against unauthorized modification. The data object to be protected has a digital signature created for it at the time it is published. Subsequently, whenever a copy of that data object is to be installed in a computer, the operating system verifies the digital signature against the contents of the data object in order to detect if the contents have changed since the time it was published. In similar fashion to SSL, the digital certificate used by any publisher to sign their data object(s) must chain back to a trusted Root Public Key. Therefore, Object Signing is vulnerable to the same types of attack as SSL, with the effect that an attacker can surreptitiously introduce illegitimate software including viruses and so-called “spy-ware” into an end user's computer, without triggering Object Signing safeguards.

A further type of identity fraud is known as “phishing”, whereby e-mail purporting to be from an institution is sent by an attacker to customers of that institution. Such email may appear genuine, and can seek to elicit personal details such as account numbers and passwords, or can direct customers to web sites that may be ghost sites or may otherwise harm the customer's computer. Counter-measures against phishing may incorporate cryptographic technologies that encrypt legitimate communications from institutions to their customers, and/or authenticate the sender of said communications. However, once again, common Internet and e-commerce applications today do not offer sufficiently robust protection against Public Key substitution in order to support cryptographic defenses against phishing.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect, the present invention provides a method for a first party to verify an identity of a second party in an electronic communication environment, the method comprising:

storing in a tamper resistant storage device held by the first party at least one cryptographic Public Key associated with at least one electronic security protocol of the second party; and

verifying to the first party the identity of the second party by using the at least one cryptographic Public Key stored on the tamper resistant storage device in accordance with the at least one electronic security protocol.

According to a second aspect the present invention provides a system for a first party to verify an identity of a second party in an electronic communication environment, the system comprising:

a tamper resistant storage device held by the first party and storing at least one cryptographic Public Key associated with at least one electronic security protocol of the second party; and

means for verifying to the first party the identity of the second party by using the at least one cryptographic Public Key stored on the tamper resistant storage device in accordance with the at least one electronic security protocol.

According to a third aspect the present invention provides a client software application for verifying an identity of a second party in an electronic communication environment, the client software application comprising:

code for verifying the identity of the second party by using at least one cryptographic Public Key stored on a tamper resistant storage device in accordance with at least one electronic security protocol of the second party.

According to a fourth aspect the present invention provides a tamper resistant storage device storing at least one cryptographic Public Key associated with at least one electronic security protocol of a second party, the tamper resistant storage device for use by a first party in verifying the identity of the second party by using the at least one cryptographic Public Key stored on the tamper resistant storage device in accordance with the at least one electronic security protocol.

Storage of the cryptographic Public Key in a tamper resistant device, such as a smart card, obviates the need to rely on a Public Key stored in a Trust List on magnetic disc or random access memory. Hence, even should an attacker alter entries in any such Trust List, a trusted Public Key can be obtained from the tamper resistant storage device. Thus, in accordance with the present invention, a tamper resistant storage device in the possession of the first party provides a trusted copy of the cryptographic Public Key of the second party. Accordingly, the invention makes use of removable and/or portable tamper resistant cryptographic devices such as smartcards to protect an institution's cryptographic Public Key(s), and in turn to improve the cryptographic security of Internet and e-commerce applications.

Accordingly, embodiments of the present invention may substantially alleviate the broad problem of Public Key substitution, by safeguarding certain Public Keys of the institution within the tamper resistant storage device. That is, embodiments of the present invention may enable alleviation of security concerns surrounding several classes of online institution identity fraud, including ghosting, Man in the Middle attacks, and phishing.

The present invention is further particularly advantageous where the second party, such as a health institution, has in any event already issued a tamper resistant storage device to the first party. That is, the present invention recognizes that tamper resistant cryptographic devices such as smartcards are becoming increasingly widespread for various reasons, particularly protection against personal identity theft perpetrated against institutions' customers. Unlike magnetic stripe cards, smartcards and functionally similar removable cryptographic devices are very difficult to duplicate, and are thus considered to be tamper resistant storage devices in accordance with the present invention. For example, information held within the internal memory of a “smart” cryptographic device generally cannot be accessed without first presenting a correct personal identification number (PIN). In some cryptographic devices certain data, such as cryptographic Private Keys, are prevented by the device's internal operating system from ever being transmitted from the device. Such a cryptographic device cannot be duplicated by an attacker even if the attacker has gained knowledge of the device's PIN. These properties of such portable cryptographic devices (and in particular smartcards) in effect make them immune to “skimming”, being the form of identity theft where magnetic stripe cards are illicitly duplicated by copying data directly from one card's stripe to another's.

The present invention has recognized that smartcards and other functionally similar tamper resistant portable cryptographic devices are also becoming increasingly desirable, and increasingly issued by institutions to their customers, due to steadily enhanced levels of support in standard Internet software, operating systems and commercial computer hardware. For example, credit card companies have announced that in future, magnetic stripe card technology must be replaced by smartcard technology. Therefore, the present invention takes advantage of the recognition that customers of online institutions, especially financial institutions, will in future carry smartcards or other functionally similar removable cryptographic devices with which to authenticate themselves for access to electronic business services.

That is, the present invention recognizes that, not only may such smartcards be used to prevent customer identity theft in the manner set out in the preceding, but that the customer-carried smartcard may be used by an institution to protect their own online identity. Advantageously, such protection may be afforded to the institution by use of existing customer smartcards for storage of the institution's Public Key, in accordance with the present invention, whether or not that smartcard was issued by the institution. Accordingly, in instances where the first party such as a customer already holds a suitable tamper resistant storage device in which the Public Key of the second party such as an institution may be stored, no additional infrastructure in the way of additional smartcards is required. Rather, the second party or institution needs merely to arrange for a trusted copy of the Public Key to be stored within the existing tamper resistant storage device of the first party or customer.

The tamper resistant storage device may further store other cryptographic elements, such as SSL digital certificate chains, Root Public Keys and/or multiple institution Public Keys.

Furthermore, in some embodiments of the invention a smartcard or other tamper resistant storage device issued by or on behalf of a first institution may be used to store one or more trusted Public Keys of other parties or institutions. Thus, in some such embodiments the tamper resistant storage device may hold a plurality of trusted Public Keys relating to a plurality of institutions.

In embodiments of the invention the first party may be a client and the second party may be a server. For example the client may be client software operating on a computing platform, operating in conjunction with a tamper resistant storage device.

In further embodiments of the invention the first party may be a customer and the second party may be a business. For example the second party may be any one or more of a credit card provider, a health institution, a government agency, a telecommunications company, a licensing body, a gaming body, a software publisher, a software distributor, a merchant, and a financial institution.

In embodiments of the invention, the tamper resistant storage device may comprise a portable device having an in built security module, for example a smartcard, a subscriber identity module (SIM card), a cryptographic universal serial bus (USB) storage device; and/or a wireless portable computing device with tamper resistant storage, such as a Blackberry®.

In preferred embodiments the tamper resistant storage device is a portable and removable device to be held by a customer. In such embodiments, the tamper resistant storage device preferably communicates with application software through logical, communications and physical interfaces to enable use of the Public Key by the application software in accordance with the electronic security protocol. The physical interface may be a contact smartcard reader, a contactless smartcard reader, a wireless network interface, USB port, serial port, parallel port, or SIM card receptacle. The communications interface may include software drivers for a device reader. The logical interface may be an application programming interface to provide application software with the means to make use of cryptographic keys and other data held securely within the tamper resistant storage device.

In embodiments of the invention, application software of the first party may make use of the Public Key of the second party by making a temporary copy of the Public Key outside the tamper resistant storage device. Alternatively, the application software may feed data into the tamper resistant storage device causing functions to be executed within the device so that the Public Key need not leave the device.

It will be appreciated that the present invention provides for secure storage of a Public Key for use in any applicable electronic security protocol. For example the electronic security protocol may be one or more of Secure Multipurpose Internet Mail Extensions (S/MIME), Pretty Good Privacy (PGP), Open Standard for Pretty Good Privacy (OpenPGP), Privacy Enhancements for Internet Electronic Mail (PEM), Secure Sockets Layer (SSL), Transport Layer Security (TLS), Wireless Transport Layer Security (WTLS), Extensible Markup Language (XML) Signatures, Internet Protocol Security (IPSEC), Authenticode™ object signing, Java Archive (JAR) object signing, Visual Basic for Applications (VBA) object signing, and Netscape Navigator object signing.

According to a fifth aspect the present invention provides a means of protecting an electronic business institution from identity theft, said means comprising removable cryptographic devices issued to the institution's customers, and application programming interfaces, where said removable devices contain tamper-resistant copies of cryptographic Public Keys of the institution, said Public Keys being associated with standard electronic business security functions used by the institution to transact with its customers.

In some embodiments of the invention copies of one or more certificates in the digital certificate chain for an SSL-secured web site, from the Root Public Key through to the server certificate, may be stored in the removable cryptographic device and verified by application software when establishing an SSL session.

In further embodiments of the invention a copy of a Public Key of the institution may be stored in the removable cryptographic device and used to verify secure e-mail sent by the institution.

In still further embodiments of the invention a copy of a Public Key of the institution may be stored in the removable cryptographic device and used to verify digitally signed data objects sent by the institution.

According to a sixth aspect, the present invention provides a method of protecting an electronic business institution from identity theft, said method comprising the steps of making available to customers copies of cryptographic Public Keys of the institution, storing said Public Keys in tamper-resistant removable cryptographic devices, and having customers' application software utilize the Public Keys in said removable cryptographic devices to effect standard electronic business security functions.

### BRIEF DESCRIPTION OF THE DRAWING

By way of example only, a preferred embodiment of the invention will be described with reference to the accompanying drawing which illustrates implementation of the present invention in providing secure electronic communications between a customer and an institution.

### DETAILED DESCRIPTION OF THE INVENTION

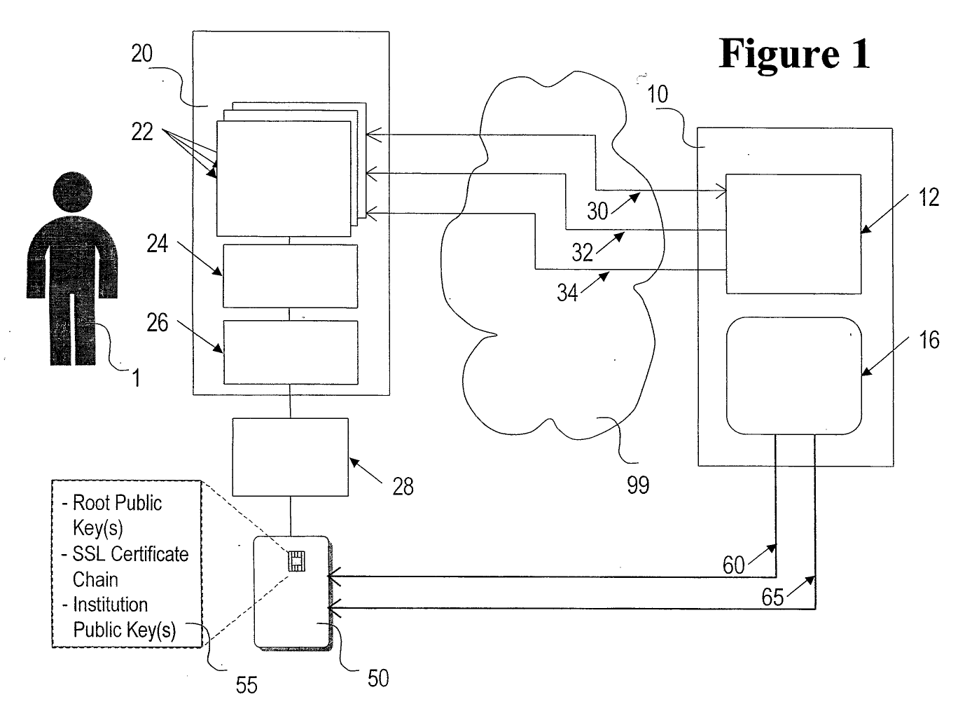

With reference to FIG. 1, an online Institution 10 and a Customer 1 of said institution transact with one another over a Communications Network 99 using a Web Server 12 and one or more Internet Applications 22 running on the Customer's Computer 20. The Internet Applications 22 can (without limitation) include web browser, e-mail, and/or special purpose transaction software written by or on behalf of the Institution 10. In a preferred embodiment, Internet Applications 22 interface to a Smartcard 50 via a Smartcard Reader 28, Smartcard Reader Driver software 26 and a Cryptographic Application Programming Interface (Crypto API) 24. The Crypto API 24 software enables Internet Applications 22 to make use of cryptographic keys stored within the Smartcard 50 instead of keys customarily stored elsewhere in memory in the Customer Computer 20, where said keys would be vulnerable to substitution attacks.

Still referring to FIG. 1, three types of low level electronic security function are illustrated, any or all of which are utilized by the Internet Applications 22 in order to effect high level transactions between the Institution 10 and its Customer 1, the three types of low level security function being:
i. Secure Sockets Layer (SSL) 30 which allows secure web sessions to be conducted by the Customer 20 on the Institution's Web Server 12.
ii. Secure E-mail 32 which allows the Institution 10 and Customer 1 to exchange encrypted and/or authenticated electronic messages quickly and economically; in particular, in respect of a preferred embodiment, the Institution 10 uses Secure E-mail 32 to send important notices to its Customer 1 in order to combat phishing.
iii. Signed Objects 34 which allow the Institution 10 to send particular data objects to the Customer 1 (including without limitation software upgrades, text of important notices and business data files) where standard Object Signing verification functions in the operating system of the Customer Computer 20 can check the veracity and integrity of said data objects before the objects are installed.

In a preferred embodiment, the Institution 10 issues and distributes 60 a Smartcard 50 to the Customer 1. The Smartcard 50 is pre-loaded by (or on behalf of) the Institution 10 with one or more Public Keys 55, all held in the Smartcard's tamper resistant memory. Said Public Keys are organized in standard Public Key Certificate formats. The Public Keys so held may include any or all of the following:
A copy of the Root Public Key of each trusted certificate issuer used by the Institution 10; in the preferred embodiment Root Public Keys stored in the Smartcard 50 are used by Internet Applications 22 instead of any customary Trust List stored elsewhere in memory in the Customer Computer 20.
A copy of the entire digital certificate chain from Root Public Key through to server certificate for the SSL-secured Web Server 12.
A copy of a Public Key to be used to decrypt Secure E-mails 32 sent by the Institution 10 to Customer 1 in order to verify that said Secure E-mail did indeed originate from the Institution 10.
A copy of a Public Key to be used to verify the digital signature on Secure E-mails 32 sent by the Institution 10 to Customer 1.
A copy of a Public Key to be used to verify the digital signature of Signed Objects 34 sent by the Institution 10 to Customer 1.

The invention improves the security of the low level electronic business security functions SSL, Secure E-mail and Object Signing as used by the Institution 10, by storing in the Smartcard 50 all Public Keys used by said low level functions. When thus stored in a tamper-resistant Smartcard 50, said Public Keys cannot be readily substituted or otherwise interfered with by an attacker. Whenever Internet Applications 22 need to verify the origin of a Secure E-mail 32 or a Signed Object 34, the application software uses the necessary Public Keys 55 in the Smartcard 50.

Further, to protect against Man In The Middle attacks on SSL, whether before, during or after establishment of a standard SSL session 30, Internet Applications 22 can verify that the certificate chain for the Web Server 12 matches the SSL certificate chain 55 stored in the Smartcard 50. If the certificate chains are found not to match, then the web site can be assumed to be a ghost site, and the application software can terminate the web session before any harm can be done by the ghost web server.

Further, to protect against phishing, the Institution 10 can use Secure E-mail 32 to effect important business communications with Customer 1 and/or Object Signing 34 to protect important business information against attack.

From time to time, for operational reasons or because digital certificates expire, the Institution 10 will need to replace or renew its various Public Keys. At such times, the Institution 10 can inject copies of all new Public Key data 55 into the Smartcard 50 via a standard secure protocol for Smartcard Data Download 65. Several standard methods are available for such secure data download, as will be appreciated by persons skilled in computer security. The efficacy of the present invention does not depend on the details of whatever secure data download method is used in the renewal of the institution's Public Keys.

More generally, it will be appreciated by persons skilled in the art that numerous variations and/or modifications may be made to the invention as described in the specific embodiments disclosed herein, without departing from the spirit or scope of the invention as broadly described. It will be particularly appreciated that the present invention can be constructed using a variety of alternate but standard components for the application software, smartcard or functionally similar removable cryptographic device, removable cryptographic device reader, and/or reader drivers, without materially affecting the efficacy of the invention in respect of combating online institution identity fraud through protection of Public Keys of the institution used in low level security functions. Further, it will be realized that a variety of removable cryptographic devices are available with similar functions in respect of secure storage of cryptographic keys but packaged in different forms, including without limitation plastic cards with embedded integrated circuit chip and Universal Serial Bus (USB) tokens or “smart keys”, and that the present invention can be constructed from such alternate devices without affecting the scope or spirit of the invention in regard to protecting an institution's Public Keys and securely making them available to the institution's customers. The present embodiments are, therefore, to be considered in all respects as illustrative and not restrictive.

1-79. (canceled)

80. A method for a first party to verify an identity of a second party in an electronic communication environment, the method comprising:
storing in a tamper resistant storage device held by the first party at least one cryptographic Public Key associated with at least one electronic security protocol of the second party; and
verifying to the first party the identity of the second party by using the at least one cryptographic Public Key stored on the tamper resistant storage device in accordance with the at least one electronic security protocol.

81. The method of claim 80 wherein information stored in the tamper resistant storage device can be accessed only by presenting a correct personal identification number (PIN).

82. The method of claim 80 wherein at least a portion of data held by the tamper resistant storage device is prevented by an internal operating system of the tamper resistant storage device from ever being transmitted from the device.

83. The method of claim 80 wherein the tamper resistant storage device further enables authentication of the identity of the first party.

84. The method of claim 83 wherein the tamper resistant storage device enables authentication of the identity of the first party for the electronic security protocol.

85. The method of claim 83 wherein the tamper resistant storage device stores a Private Key associated with the first party.

86. The method of claim 80 wherein the first party comprises a client and the second party comprises a server.

87. The method of claim 80 wherein the second party comprises at least one of a credit card provider, a health institution, a government agency, a telecommunications company, a licensing body, a gaming body, a software publisher, a software distributor, a merchant, and a financial institution.

88. The method of claim 80 wherein the tamper resistant storage device comprises at least one of a smartcard, a subscriber identity module (SIM card), a cryptographic universal serial bus (USB) storage device and a wireless portable computing device with tamper resistant storage.

89. The method of claim 80, wherein the electronic security protocol comprises at least one of Secure Multipurpose Internet Mail Extensions (S/MIME), Pretty Good Privacy (PGP), Open Standard for Pretty Good Privacy (OpenPGP), Privacy Enhancements for Internet Electronic Mail (PEM), Secure Sockets Layer (SSL), Transport Layer Security (TLS), Wireless Transport Layer Security (WTLS), Extensible Markup Language (XML) Signatures, Internet Protocol Security (IPSEC), Authenticode™ object signing, Java Archive (JAR) object signing, Visual Basic for Applications (VBA) object signing, and Netscape Navigator object signing.

90. The method of claim 80, further comprising storing in the tamper resistant storage device at least one of a Root Public Key and a security protocol certificate chain.

91. The method of claim 80 wherein using the at least one cryptographic Public Key to verify the identity of the second party comprises communicating the cryptographic Public Key from the tamper resistant storage device via a device interface to a software application.

92. The method of claim 80 wherein using the at least one cryptographic Public Key to verify the identity of the second party comprises causing functions to be executed within the tamper resistant storage device without the cryptographic Public Key leaving the tamper resistant storage device.

93. A system for a first party to verify an identity of a second party in an electronic communication environment, the system comprising:
a tamper resistant storage device held by the first party and storing at least one cryptographic Public Key associated with at least one electronic security protocol of the second party; and
means for verifying to the first party the identity of the second party by using the at least one cryptographic Public Key stored on the tamper resistant storage device in accordance with the at least one electronic security protocol.

94. A client software application for verifying an identity of a second party in an electronic communication environment, the client software application comprising:
code for verifying the identity of the second party by using at least one cryptographic Public Key stored on a tamper resistant storage device held by a first party in accordance with at least one electronic security protocol of the second party.

95. A tamper resistant storage device storing at least one cryptographic Public Key associated with at least one electronic security protocol of a second party, the tamper resistant storage device to be held by a first party for use in verifying the identity of the second party by using the at least one cryptographic Public Key stored on the tamper resistant storage device in accordance with the at least one electronic security protocol.
